(19) United States
(12) Patent Application Publication
(10) Pub. No.: US 2026/0287145 A1
(43) Pub. Date: Sep. 24, 2026

(54) LIGHT SOURCE ASSEMBLY AND LAMP

(71) Applicants: OPPLE LIGHTING CO., LTD., Shanghai (CN); SUZHOU OPPLE LIGHTING CO., LTD., Suzhou City (CN)

(72) Inventors: Haisheng LIU, Shanghai (CN); Haiqiang HU, Shanghai (CN); Chaobo LIU, Shanghai (CN); Xiaotong YANG, Shanghai (CN)

(73) Assignees: OPPLE LIGHTING CO., LTD., Shanghai (CN); SUZHOU OPPLE LIGHTING CO., LTD., Suzhou City (CN)

(21) Appl. No.: 19/686,621

(22) Filed: May 23, 2026

Related U.S. Application Data
(63) Continuation of application No. PCT/CN2024/133846, filed on Nov. 22, 2024.

(30) Foreign Application Priority Data
Nov. 24, 2023 (CN) 202323178267.3

(51) Int. Cl. F21V 5/00; F21Y 105/18; F21Y 113/13; F21Y 115/10

(52) U.S. Cl. CPC F21V 5/007; F21Y 2105/18; F21Y 2113/13; F21Y 2115/10

(57) ABSTRACT

A light source assembly and a lamp are provided. The light source assembly includes a light source substrate and at least two types of light emitting units disposed on the light source substrate. Each type of light emitting unit includes at least two light emitting components having different colors. The at least two types of light emitting units are distributed in a staggered manner on the light source substrate. Light emitting components in two adjacent light emitting units of the same type have different color arrangements. By arranging different types of light emitting units in a staggered pattern and varying the color arrangements of adjacent light emitting units of the same type, color mixing performance is improved, color separation is reduced, and more uniform illumination and enhanced lighting effects are achieved. The light source assembly may be applied to various lighting devices and display lamps.

This disclosure is based upon and claims the priority of PCT patent disclosure No. PCT/CN2024/133846 filed on Nov. 22, 2024, which claims priority to the Chinese patent disclosure No. 202323178267.3 filed on Nov. 23, 2023, the entire contents of which are hereby incorporated by reference herein for all purposes.

### TECHNICAL FIELD

The present disclosure relates to the field of lighting, and in particular, to a light source assembly and a lamp.

### BACKGROUND

With the improvement of living standards, people have increasingly higher requirements for lighting in various scenarios. Lamps capable of simulating outdoor natural ambient light have gained growing market popularity and are widely used for indoor lighting in residences, office buildings, shopping malls, stadiums, stations, airports and other places.

### SUMMARY

The present disclosure provides a light source assembly.

Accordingly, the light source assembly provided may include:
a light source substrate and at least two types of light emitting units disposed on the light source substrate.

Each type of light emitting unit includes at least two light emitting components having different colors. The at least two types of light emitting units are distributed in a staggered manner, and the light emitting components in two adjacent light emitting units of the same type have different color arrangements. In some embodiments, the light source assembly includes a plurality of light emitting modules arranged in a transverse, longitudinal, array, annular, concentric-circle, square-ring, or other predetermined pattern. In some embodiments, the light emitting units and/or the light emitting components are independently controllable. The light source assembly may be incorporated into a lamp to provide various lighting effects.

It is to be understood that both the foregoing general description and the following detailed description are exemplary and explanatory only and are not restrictive of the present disclosure.

### BRIEF DESCRIPTION OF DRAWINGS

FIG. 1 is a three-dimensional structural view of a lamp according to an example of the present disclosure.

FIG. 2 is a cross-sectional view of the lamp shown in FIG. 1.

FIG. 3 is an exploded structural view of the lamp shown in FIG. 1.

FIG. 4 is a schematic plan view of a light source assembly in the lamp shown in FIG. 3.

FIG. 5 is a schematic view of a light emitting module in the light source assembly shown in FIG. 3.

FIG. 6 is a schematic view of a second light emitting module in the lamp shown in FIG. 3.

FIG. 7 is an exploded structural view of Example 2 of a second light source system in the present disclosure.

FIG. 8 is a schematic view of a second light emitting module in FIG. 7.

FIG. 9 is an exploded structural view of a light guide member of Example 3 of a second light source system in the present disclosure.

FIG. 10 is a three-dimensional structural view of a projection apparatus according to an example of the present disclosure.

FIG. 11 is an exploded structural view of the projection apparatus shown in FIG. 10.

FIG. 12 is an illumination effect diagram of a lamp according to an example of the present disclosure.

FIG. 13 is an illumination effect diagram of a first light source system and a second light source system of a lamp according to an example of the present disclosure.

### DETAILED DESCRIPTION

To make the objectives, technical solutions and advantages of the present disclosure clearer, the present disclosure will be described in detail below with reference to the accompanying drawings and examples.

It should be noted herein that to avoid obscuring the present disclosure with unnecessary details, the accompanying drawings only show structures and/or processing steps closely related to the solutions of the present disclosure, and omit other details irrelevant thereto.

In addition, it should be noted that the terms “comprise”, “include” and any other variants thereof are intended to cover non-exclusive inclusion, such that a process, method, article or apparatus comprising a set of components includes not only those components, but also other components not expressly listed, or components inherent to such process, method, article or apparatus.

### REFERENCE NUMERALS USED IN THIS DISCLOSURE MAY INCLUDE

100—Lamp
200—First light source system, 201—First light exit surface, 210—Light source assembly, 211—Light source substrate, 212—Light emitting module, 2121—First light emitting unit, 2122—Second light emitting unit, 220—Diffusion structure, 240—Transparent plate, 250—Inner frame;
300—Second light source system, 301—Second light exit surface, 302—Non-light exit surface, 303—Virtual image, 304—Light and shadow transition region, 310—Second light emitting module, 311—Flexible substrate, 312—Light emitting component, 320—Light guide assembly, 321—Light output component, 322—Light guide member, 3221—V-prism micro structure, 323—Reflective member, 324—Light shielding member, 325—Annular lens;
400—Projection system, 410—Projection device, 420—Light emitting assembly, 421—Aluminum substrate, 422—LED bead, 430—Lens module, 431—First lens, 432—Second lens, 433—Third lens, 451—First lens barrel, 452—Second lens barrel, 453—Third lens barrel, 440—Diaphragm;
500—Mounting system;
600—Housing, 610—Bottom wall, 620—Frame.

Some sky lamps are generally composed of a light source and a pattern plate printed with blue sky and white cloud patterns. The light source illuminates the pattern plate to form an outdoor blue sky lighting atmosphere. However, such solution fails to truly present the matching effect of blue sky and sunlight, featuring poor layering, lack of three-dimensional sense and low simulation fidelity.

In response to this issue, sky lamps adopting a combination of a light source and a diffuser panel have emerged on the market to form sunlight similar to natural sunlight. Nevertheless, they adopt relatively single light source and cannot present light variation, resulting in unsatisfactory lighting effects.

In view of the above deficiencies, it is indeed necessary to provide a light source assembly and a lamp which can truly simulate natural light effects at different time periods.

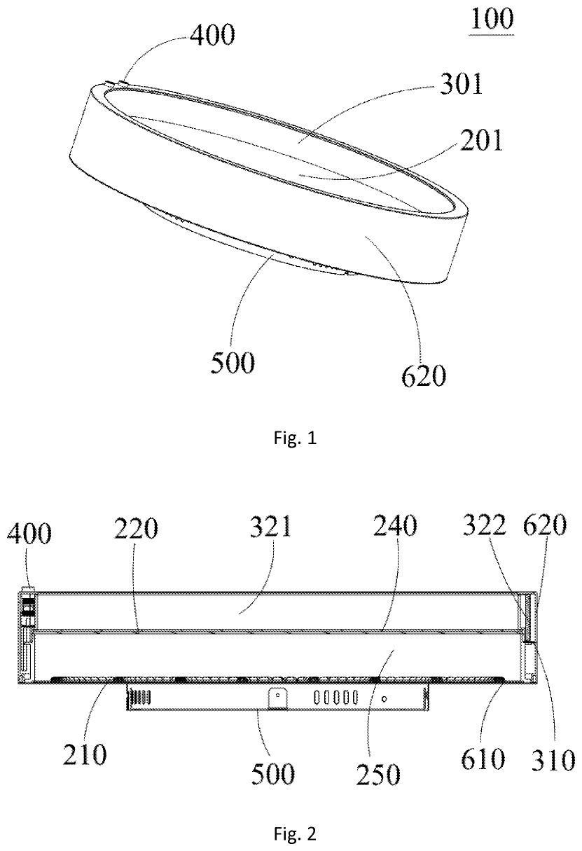

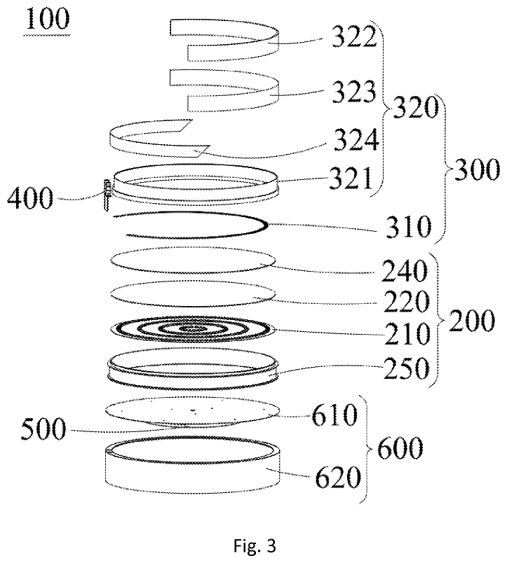

Please refer to FIGS. 1 to 3, which illustrate a lamp 100 according to an example of the present disclosure. The lamp includes a first light source system 200, a second light source system 300 and a projection system 400. The first light source system 200 is configured to simulate sunlight in different periods in nature. The second light source system 300 is arranged around the outer side of the first light source system 200 and configured to simulate the lighting effect of sunlight irradiating the edge of a skylight, in addition, the second light source system 300 can further form a virtual image 303. The projection system 400 is disposed on the side of the second light source system 300, and is configured to form a light spot on the ground or wall surfaces.

In other examples, the first light source system 200 may also be referred to as a surface light source system, and the second light source system 300 may also be defined as a side-emitting light system.

The lamp 100 includes a housing 600, the housing 600 includes a bottom wall 610 and a frame 620 extending from the bottom wall 610 in a direction away from the bottom wall 610. A light outlet is formed between the bottom wall 610 and the frame 620. The first light source system 200 includes a light source assembly 210 and a diffusion structure 220. The light source assembly 210 is fixedly connected to the bottom wall 610 and configured to emit light toward the diffusion structure 220. The diffusion structure 220 is mounted inside the frame 620 and covers the light source assembly 210, and the diffusion structure 220 is configured to uniformize light emitted by the light source assembly 210. The light source assembly 210 is configured as the light source for forming a first light exit surface 201.

In an optional example, the first light source system 200 is a ceiling lamp including a base plate, a face cover and the light source assembly 210, the light source assembly 210 may be a full-spectrum LED chip capable of simulating sunlight spectrum. In other examples, the light source assembly 210 may also be a common white light source, nanoparticles are added into the diffusion structure 220 of the first light source system 200 to from Rayleigh scattering, so that the first light exit surface 201 presents sky blue color, which is not limited in the present disclosure.

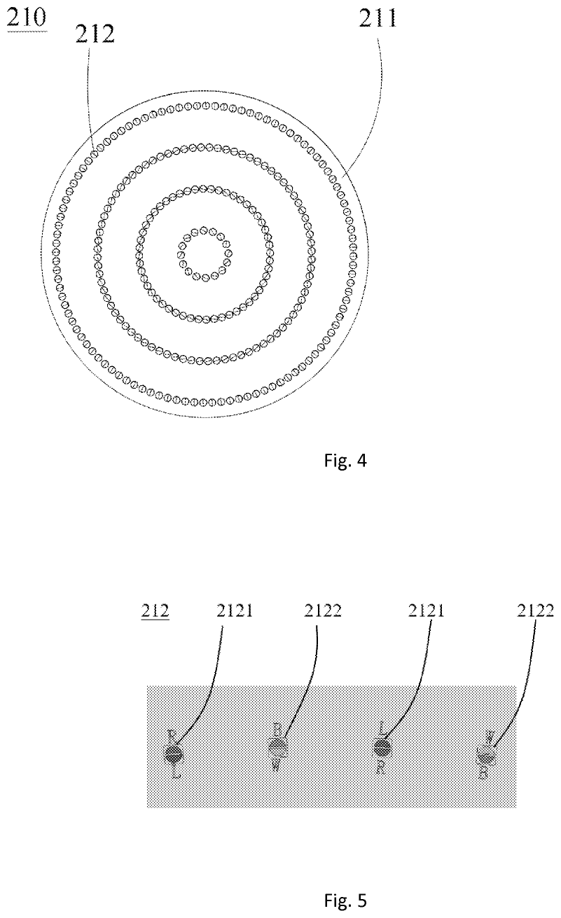

Please refer to FIGS. 2 to 5, in an example of the present disclosure, the first light source system 200 includes a light source assembly 210 and a diffusion structure 220. The light source assembly 210 comprises a light source substrate 211 and a plurality of light emitting modules 212. The light source substrate 211 is fixedly connected to the bottom wall 610. The light emitting modules 212 are mounted on the side of the light source substrate 211 away from the bottom wall 610 and electrically connected through the light source substrate 211.

Each light emitting module 212 includes at least two types of light emitting units, and the at least two types of light emitting units are capable of emitting light with at least two different spectra. The at least two types of light emitting units are arranged alternately, and adjacent light emitting units of the same type are arranged in reverse order.

In this example, the light emitting units in the light emitting module 212 are arranged transversely. In other examples, the light emitting units in the light emitting module 212 may also be arranged longitudinally, in an array or in a ring shape, which is not limited by the present disclosure.

As shown in FIG. 5, in an example, each light emitting module 212 on the light source assembly 210 includes a first light emitting unit 2121 and a second light emitting unit 2122, the first light emitting unit 2121 and the second light emitting unit 2122 are arranged alternately, and every two adjacent first light emitting units 2121 or every two adjacent second light emitting units 2122 are arranged in reverse order. The first light emitting unit 2121 includes any two kinds of light emitting components of four different colors, and the second light emitting unit 2122 includes the remaining two kinds of light emitting components of the four different colors. In a single light emitting module, the units are arranged in sequence from left to right as: first light emitting unit 2121, second light emitting unit 2122, first light emitting unit 2121 and second light emitting unit 2122. The two types of light emitting units, that is, the first light emitting unit 2121 and the second light emitting unit 2122, are arranged alternately, and adjacent first light emitting units 2121 or adjacent second light emitting units 2122 are arranged reversely. By adopting the four-color light emitting components, diversified lighting effects can be realized. The alternate arrangement of light emitting units of different types and reverse arrangement of light emitting units of the same type enable the first light source system 200 to emit light with more uniform chromaticity, simulate sunlight colors at different times, and achieve dynamic light effects.

Both the first light emitting unit 2121 and the second light emitting unit 2122 are dual-cup lamp beads, the dual-cup lamp bead includes two beads of light emitting components of different colors, and the light emitting component is a light emitting chip.

In this example, the first light emitting unit 2121 includes any two colors selected from a group consisting of white, green, blue and red, and the second light emitting unit 2122 includes the other two remaining colors different from the two colors of the first light emitting unit 2121 in the group consisting of white, green, blue and red.

In this example, each light emitting module includes two first light emitting units 2121 and two second light emitting units 2122. In other examples, the number of the first light emitting units 2121 and the second light emitting units 2122 in the light emitting module 212 may be more, which is not limited in the present disclosure.

A light source lens (not shown) is sleeved on the light emitting unit of the light emitting module. In this example, the light source lens is mounted on each light emitting unit, that is, the light source lenses and the light emitting units are arranged in one-to-one correspondence. This arrangement enables the light emitted by the light emitting units to converge to the center of the light source lens and then radiate outward, avoiding mutual light interference. In other examples, the light source lens may also be an integrated lens such as two-in-one or four-in-one lens, to allow a single light source lens to cover more light emitting units, or a single light source lens to cover all light emitting units, which can reduce the usage quantity of lenses and facilitate production and assembly.

In this example, the light emitting units are arranged in a circular pattern on the light source substrate 211, specifically, in a plurality of concentric circles. The number of the light emitting units in each circle is a multiple of 6, 7 or 8, the number of the light emitting units in each circle is determined according to the voltage of the light emitting units and the driving power supply. In this example, the voltage of the lamp bead is 3V and the driving voltage is 24V, so an eight-in-one series connection mode is adopted, that is, the number of the light emitting units in each concentric circle is a multiple of eight.

In this example, the light source substrate 211 is provided with Ri circles of light emitting units, where i≥2. The number of light emitting units in the R1-th circle is N, the number of light emitting units in the R2-th circle is 2N, and the number of light emitting units in the Ri-th circle is i*N. Assuming the R1-th circle includes one series marked as 1_1, the R2-th circle includes two series marked as 2_1 and 2_2, and so on, the Ri-th circle is marked from i_1 to i_i. The total number of series is i(i+1)(i+2)/6, it is equivalent to being able to adjust i*(i+1)*(i+2)/6 series of painting bundles. Because of four light emitting components of different colors, it is possible to perform color and brightness adjustment for 4i(i+1)(i+2)/6 regions. The control system precisely regulates the power of light emitting modules in different regions, so as to realize continuous light variation from morning to night. In other examples, each light emitting unit or light emitting component can be controlled independently. By adjusting the operating state and power of each light emitting module 212, each light emitting unit or each light emitting component, the overall light source assembly 210 can present different display effects such as lighting effects of morning glow and sunset glow.

In other examples, the light emitting units may also be arranged in a multi-loop square-ring pattern or other shapes on the light source substrate 211, which is not limited in the present disclosure.

The first light source system 200 includes a diffusion structure 220 and an inner frame 250. The inner frame 250 is sleeved inside the frame 620, and the diffusion structure 220 is fixedly connected to the end of the inner frame 250 away from the light source assembly 210. Light emitted by the light emitting units in the light source assembly 210 passes through the diffusion structure 220, the diffusion structure 220 performs light diffusion on the light and converts linear or point light sources into uniform surface light sources. In this example, the diffusion structure 220 is a diffusion plate, a light transmittance of the diffusion plate ranges from 40% to 65%, and a thickness of the diffusion plate is about 3 mm.

The diffusion plate can better eliminate the grainy feeling of emitted light from the light source assembly and realize light scattering function, that is, light is scattered on the surface of the diffusion plate and emitted softly and evenly. After being diffused by the diffusion plate, the light achieves a larger irradiation area with better uniformity and stable chromaticity.

In other examples, the diffusion structure 220 may also be a structural member with micro structures, which also covers the light emitting module and achieves better light homogenization effects, and the present disclosure do not limit this.

In some examples, the first light source system 200 further includes a transparent plate 240. The transparent plate 240 is fixedly connected to the end of the inner frame 250 away from the light source assembly 210, and is disposed on the side of the first light exit surface 201 away from the light source assembly 210. The side of the transparent plate 240 away from the first light exit surface 201 is a mirror surface, at least part of the light emitted by the second light source system 300 passes through the second light exit surface 301 and projects onto the transparent plate 240, then is reflected by the transparent plate 240 to form a virtual image 303. This simulates the window shadow effect formed on a window when one side of the window is illuminated by sunlight, endowing the visual effect with a sense of depth and permeability.

The mirror surface of the transparent plate 240 has a higher light reflectivity than light transmittance, which can limit external light from entering the transparent plate 240 through the light exit surface. Optionally, the transparent plate 240 may be made of an inorganic material, the inorganic material may be quartz glass, or the transparent plate 240 may be made of an organic material, and the organic material may be a polymer transparent material such as polymethyl methacrylate, which is not limited in the present disclosure.

In some examples, a thin unidirectional film layer made of tin, silver, aluminum or the like is coated on the light exit side of the transparent plate 240 through a crystal plating process, so as to form the unidirectional film layer. The crystal plating process ensures high surface smoothness of the unidirectional film layer. In other examples, the transparent plate 240 can be selected according to actual application requirements, which is not limited. The thickness of the unidirectional film layer can be adjusted as needed. Changes in its thickness will alter the reflectivity and transmittance. The effect of single-direction perspective is achieved by setting the reflectivity higher than the transmittance.

The second light source system 300 is detachably connected to the lamp 100, the second light source system 300 is arranged between the frame 620 and the first light source system 200 and surrounding the first light exit surface 201 of the first light source system 200. The second light source system 300 extends along the light emitting direction of the light source assembly 210 and is provided with a second light exit surface 301 attached to the side of the frame 620 close to the first light exit surface 201. The second light source system 300 further includes a second light emitting module 310, which is horizontally disposed between the second light exit surface 301 and the frame 620. Light emitted by the second light emitting module 310 passes through the second light exit surface 301 and radiates away from the frame 620. Different from the light emission mode of conventional ambient lights, the second light source system 300 only emits light toward the inner side of the lamp 100. In this example, the frame 620 is made of an opaque material, which creates a visual effect that sunlight shines in and illuminates the window frame, forming a light-transmitting window effect.

The second light source system 300 further includes a non-light exit surface 302 which is also arranged away from the frame 620. A light and shadow transition region 304 is formed between the second light exit surface 301 and the non-light exit surface 302. As shown in FIG. 13, this structure simulates the scene where sunlight irradiates one side of a window frame when sunlight irradiates from one side, and forms a dark area on the other side, achieving a more realistic visual effect. The second light exit surface 301 and the non-light exit surface 302 are connected circumferentially to form an annular surface surrounding the periphery of the first light exit surface 201, and the light and shadow transition region 304 is located at the junction of the second light exit surface 301 and the non-light exit surface 302.

The second light source system 300 comprises a flexible substrate 311 surrounding the first light exit surface 201 and a light emitting component 312 arranged on the flexible substrate 311. The flexible substrate 311 includes a light emitting region close to the second light exit surface 301 and a non-light emitting region away from the second light exit surface 301, so as to form the illuminated second light exit surface 301 and the unlit non-light exit surface 302 around the first light exit surface 201. The light emitting component 312 is disposed on the light emitting region, while no light emitting component is provided on the non-light emitting region.

In some examples, the second light source system 300 further includes a light shielding member 324 disposed away from the second light exit surface 301. The second light emitting module 310 and the light shielding member 324 are jointly arranged around the side of the first light exit surface 201 close to the frame 620, so as to form the illuminated second light exit surface 301 and the unlit non-light exit surface 302 on the outer periphery of the first light exit surface 201.

The entire second light source system 300 is capable of rotating relative to the first light source system 200. A micro motor installed inside the lamp 100 drives the rotation of the second light source system 300 to better simulate the east-to-west movement of the sun.

The second light source system 300 will be described below in conjunction with three examples, which should not be construed as limitations.

As shown in FIGS. 2, 3 and 6, in this example, the light emitting direction of the second light emitting module 310 is the same as the light emitting direction of the light source assembly 210. The second light source system 300 includes the second light emitting module 310 and a light guide assembly 320, the light guide assembly 320 includes a light guide member 322 and a light output member 321. The light guide member 322 is arranged below the second light emitting module 310, the second light emitting module 310 emits light toward the light guide member 322 (that is, the second light emitting module 310 is in a direct light emitting manner). The light guide member 322 is configured to refract light emitted from the second light emitting module 310. The light output member 321 is disposed on the side of the light guide member 322 away from the frame 620. After being refracted by the light guide member 322, the light exits through the light output member 321 toward the side away from the frame 620 to emit out. The light guide member 322 can control the light emission angle to realize low-angle light output, which achieves a long projection distance and superior light permeability.

In other examples, light emitted by the second light emitting module 310 may also enter the light guide assembly 320 vertically upward, which is not limited in the present disclosure.

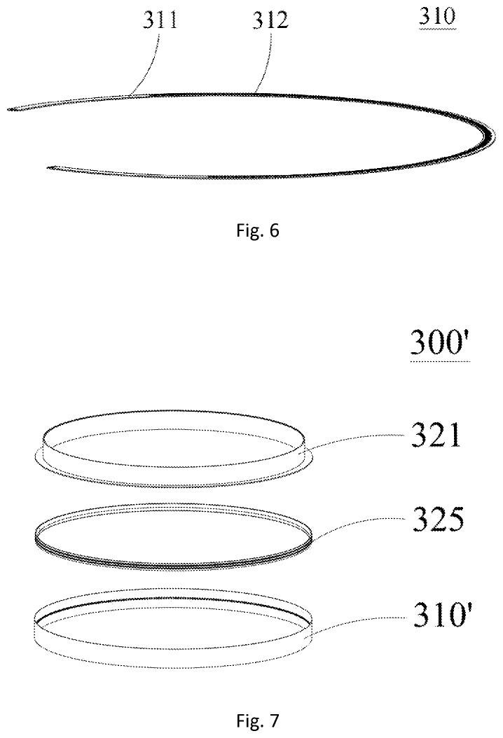

As shown in FIG. 6, the second light emitting module 310 includes a flexible substrate 311 and light emitting components 312 mounted on partial regions of the flexible substrate 311. When the light emitting components 312 on the second light emitting module 310 emit light outward, the regions of the light guide assembly 320 corresponding to the light emitting components 312 on the flexible substrate 311 are in the illuminated state (that is, the second light exit surface 301 of the second light source system 300), and the regions of the light guide assembly 320 not corresponding to the light emitting components 312 on the flexible substrate 311 are in the dark state (that is, the non-light exit surface 302 of the second light source system 300). This structure simulates the effect that sunlight penetrates a window into the room and brightens one side edge of the window.

In other examples, light emitting components 312 may be arranged over the entire region of the flexible substrate 311, and each light emitting component 312 can be independently controlled. By controlling the operating status of light emitting components in different regions and lighting up different positions to change the light source distribution, switching between the illuminated region and dark region on the light output member can be realized. It simulates sunlight irradiating the skylight edge at different angles at different time periods throughout the day to reproduce the scene of sunrise and sunset. In this example, the frame 620 is made of a semi-transparent or fully transparent material. By controlling light emitting components in different regions to emit light in different colors, a rainbow effect can be formed through the frame 620 to improve user visual experience.

Preferably, the light guide member 322 and the light output member 321 are made of transparent optical materials such as PMMA and PC.

Light exiting from the light guide member 322 passes through the light output member 321, the light output member 321 eliminates the grainy sense of light emitted by the second light emitting module 310 and the light emitted through the light output member 321 are more uniform.

A reflective member 323 is attached to the side of the light guide member 322 away from the light output member 321 to reflect incident light in this region backward, so that all light is guided to emit toward the light output member 321 and light convergence is enhanced.

The part of the light output member 321 not covered by the light guide member 322 is covered with a light shielding member 324. The light shielding member prevents light leakage from such region and ensures this region of the light output member 321 to be in the dark state, so as to simulate the effect of actual sunlight shining on the edge of windows or skylights.

In other examples, the light shielding member 324 is rotatable around the light guide member 322. When light emitting components 312 are arranged on the entire flexible substrate 311, rotating the light shielding member 324 can achieve changes between the illuminated region and dark region on the light output member 321.

The height of the light shielding member 324 can be adjusted according to actual needs by means of an elastic component matching a micro motor.

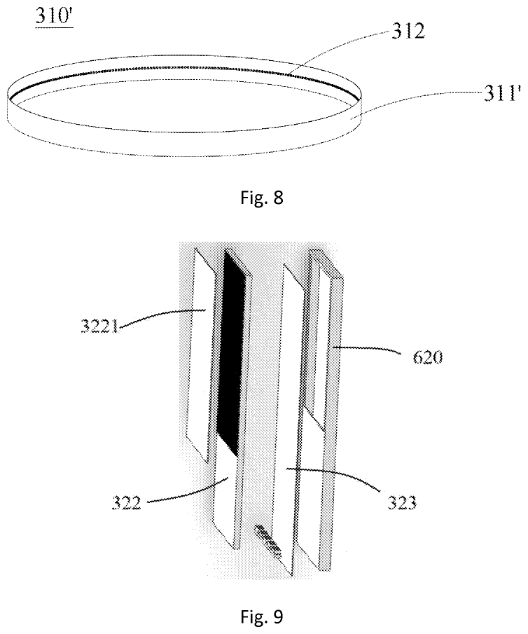

As shown in FIGS. 7 and 8, in this example, the light emitting direction of the second light emitting module 310′ intersects with the light emitting direction of the light source assembly 210. The second light source system 300 includes a light output member 321, the light output member 321 is arranged between the frame 620 and the first light exit surface 201, and the light output member 321 extends beyond the first light exit surface 201 along the extending direction of the frame 620. The second light emitting module 310′ is arranged on the side of the light output member 321 facing the frame 620, and includes an annular flexible substrate 311′ and light emitting components 312 installed on the inner side of the substrate. The second light emitting module 310′ emits light toward the light output member 321, and the emitted light directly enters the light output member 321 from the side of the light output member 321.

The second light source system 300′ further includes an annular lens 325, the annular lens 325 is between the light output member 321 and the second light emitting module 310′. The annular lens 325 is connected to the inner side of the flexible substrate 311′ and covers the light emitting components 312. Light emitted by the light emitting components 312 reaches the light incident surface of the annular lens 325, refracts at the light incident surface and enters into the lens when the Snell's law is satisfied, and then exits after refraction at the light emitting surface, the light is finally emitted uniformly through the light output member 321.

In this example, the flexible substrate 311′ is made of a flexible printed circuit (FPC), and other materials are also applicable in other examples.

Preferably, the light output member 321 is made of a transparent optical material such as PMMA, PC, or the like.

In other examples, light emitting components 312 may be arranged on the entire surface of the flexible substrate 311′, and the flexible substrate 311′ is divided into a plurality of independent lighting regions, each lighting region includes a plurality of light emitting components. Each lighting region can be controlled separately. By controlling the working state of different lighting regions, the illuminated region and dark region on the light output member 321 can be switched, simulating the effect of sunlight shining on the skylight edge at different angles at different time periods throughout the day.

In other examples, when light emitting components 312 are arranged on all regions of the flexible substrate 311′, the light shielding member 324 may be attached to partial regions of the light output member 321 to prevent light leakage in such partial regions and allow such partial regions to be in the dark state, so as to simulate the effect of real sunlight illuminating window or skylight edges. The light shielding member is rotatable, and rotating the light shielding member 324 can change the distribution of the illuminated region to simulate the effect of sunrise and sunset.

The overall structure of the second light source system 300 in this example is more concise. The second light emitting module 310′ is arranged around the outer side of the light output member 321, enabling simpler and faster assembly.

In this example, the structure of the second light source system 300 is basically the same as the structure in Example 1, the second light source system 300 only emits light toward the side away from the frame 620. The light guide assembly 320 includes a light output member 321 and a light guide member 322. The second light emitting module 310 is fixedly connected to one end of the light output member 321, and the light guide member 322 is arranged around the outer side of the light output member 321. The upper end face of the light guide member 322 covers the light emitting components 312 on the second light emitting module 310. The difference lies in that as shown in FIG. 9, the light guide member 322 in this example is provided with V-prism micro structures 3221, the V-prism micro structures 3221 are on the region away from the second light emitting module 310, and the light output member 321 includes inverted V-prism microstructures. After light is emitted from the light emitting components 312, the V-prism micro structures 3221 on the light guide member 322 break the total reflection of the light, so that light exits at a large angle from the region where the V-prism micro structures 3221 are arranged. The light emitted from the light guide member 322 enters the light output member 321 including the inverted V-prism microstructures. With the V-prism micro structures 3221, part of the light can irradiate the transparent plate 240 at a small angle and be reflected to form a transparent virtual image 303 of the second light exit surface 301.

The angles of the light-facing surface and backlight surface of the V-prism micro structures 3221 at the bottom of the light guide member 322 are both less than 6 degrees. These angles vary with the distance between the light emitting components 312 and the light incident side of the light guide member 322, and the depth of the V-grooves also changes accordingly. For the light-facing surface with an angle below 6 degrees, after light enters from the incident side, it exits the light emitting surface at an angle ranging from 165° to 175°. The V-prism micro structures 3221 on the light emitting side converge the light toward the center within 30°. The light exiting at 165° to 175° can be emitted at a small angle less than 10°via the inverted V-prisms arranged on the light output member 321. The uniformity of light emission from the light guide member 322 can be optimized by adjusting the angles of the light-facing surface and backlight surface as well as the depth of V-grooves.

Preferably, the angles of the light-facing surface and backlight surface of the V-prisms in the light guide member 322 range from 0.25° to 0.75°, and the vertex angle of the inverted V-prisms in the light output member 321 is between 55° and 70°.

A reflective member 323 covers the side of the light guide member 322 away from the light output member 321, to reflect light emitted toward this region inside the light guide member 322, so that all light inside the light guide member 322 is emitted toward the light output member 321.

The lamp 100 further includes a projection system 400, the projection system 400 is installed between the frame 620 and the second light source system 300 and partially exposed outside the frame 620. The projection system 400 is configured to project a sunlight-like light spot onto walls or the ground, the light spot includes a circular spot, an elliptical spot, a quadrilateral spot or other shapes of spot, which are similar to the projection formed when sunlight passes through windows.

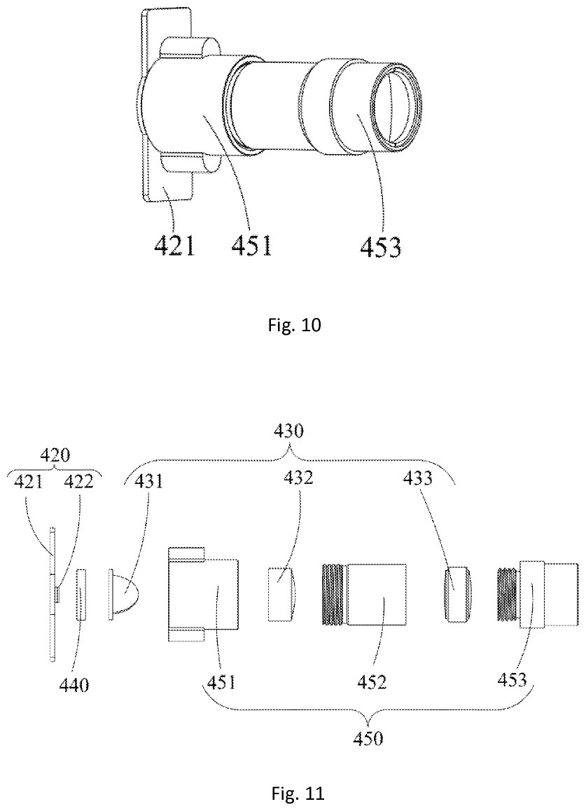

The projection system 400 includes a plurality of projection devices 410. In this example, two projection devices 410 are provided, each of the projection devices 410 is movably connected to the frame 620 of the lamp 100 through a connecting member, and the projection devices 410 is capable of rotating relative to the frame 620. As shown in FIGS. 10 and 11, the projection device 410 includes a light emitting assembly 420, a lens barrel assembly 450 and a lens assembly 430. The light emitting assembly 420 includes an aluminum substrate 421 and lamp beads 422 mounted on the aluminum substrate 421. A diaphragm 440 is sleeved outside the lamp bead 422 and the diaphragm 440 abuts against the aluminum substrate 421, the diaphragm 440 is configured to control the passing intensity and shape of the light beam emitted by the lamp bead 422. A first lens 431 is connected to the end of the diaphragm 440 away from the lamp bead 422, and the first lens 431 is configured to form a light spot. A first lens barrel 451 is sleeved on the outer sides of the diaphragm 440 and the first lens 431. A second lens barrel 452 is threadedly connected to the end of the first lens barrel 451 away from the first lens 431, a second lens 432 is embedded on the side of the second lens barrel 452 close to the first lens barrel 451. The end of the second lens barrel 452 away from the first lens barrel 451 is threadedly connected to a third lens barrel 453, a third lens 433 is embedded on the end of the third lens 433 away from the second lens barrel 452. The second lens 432 and the third lens 433 are used for imaging. The focal length can be adjusted by the first lens barrel 451, the second lens barrel 452 and the third lens barrel 453.

The first lens 431 and the second lens 432 are plastic lenses, and the third lens 433 is a glass lens. Plastic lenses have lighter weight, which helps reduce the overall structural weight, and the glass lens ensures higher light transmittance.

In this example, the lamp bead 422 is the LED bead, and other types of lamp beads are also applicable in other examples, which is not limited in the present disclosure.

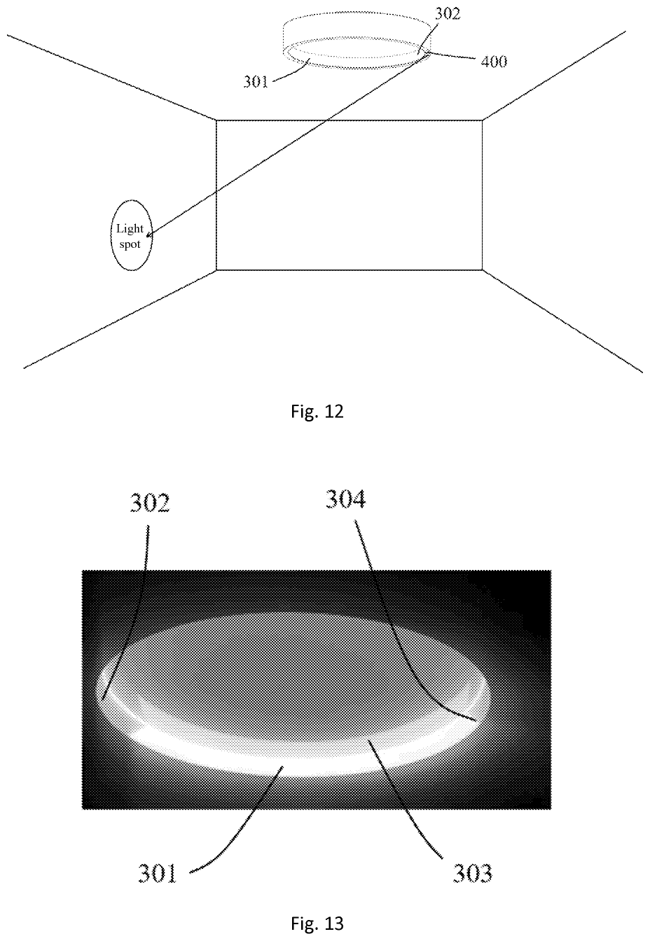

As shown in FIG. 12, the projection direction of the projection system 400 is consistent with the direction of the second light exit surface 301, enabling it to project a light spot on the wall on the corresponding side and simulate the natural projection formed on the wall when sunlight penetrates windows.

The lamp 100 further includes a control system, which controls the operation of the first light source system 200, the second light source system 300 and the projection system 400 to realize various scene lighting effects.

The mounting system 500 includes a mounting bracket, the mounting bracket is fixedly connected to the bottom wall 610, and the lamp 100 is fixed to the mounting surface through the mounting bracket. In this example, the mounting system 500 adopts a hanger-type structure, and a quick-connect structure can also be adopted in other examples, which is not limited in the present disclosure.

In summary, the first light source system 200 of the lamp 100 of the present disclosure can simulate effects such as blue sky, sunset glow, morning glow and cloud-dappled sky. The second light source system 300 simulates effects of sunlight shining on window edges, so as to achieve highly realistic lighting effects of the lamp 100. The second light source system 300 can form a virtual image 303 on the built-in transparent plate 240 to create a window shadow effect just like sunlight irradiating the edges of windows or skylights, thereby delivering spatial perception, depth sense and hierarchical sense. The projection system 400 can provide light spots similar to those formed by sunlight projecting onto the ground or walls through a window or a skylight, and the shape of the light spots can change along with the overall shape of the lamp 100, enabling application in various scenarios.

The purpose of the present disclosure is to provide a light source assembly capable of truly simulating natural light effects.

To achieve the above objective, the present disclosure provides a light source assembly, including:
a light source substrate and at least two types of light emitting units on the light source substrate, in which each of the at least two types of light emitting units includes at least two light emitting components of different colors, the at least two types of light emitting units are arranged alternately, and color arrangements of light emitting components in two adjacent light emitting units of a same type are different.

As a further improvement of the present disclosure, a first light emitting unit and a second light emitting unit are on the light source substrate, the first light emitting unit includes two light emitting components of different colors, and the second light emitting unit includes another two light emitting components of different colors different from the colors of the two light emitting components in the first light emitting unit.

As a further improvement of the present disclosure, the first light emitting unit and the second light emitting unit are arranged alternately, and the two light emitting components in adjacent first light emitting units or in adjacent second light emitting units are arranged in reverse order.

As a further improvement of the present disclosure, the first light emitting unit includes any two colors selected from a group consisting of white, green, blue and red; the second light emitting unit includes remaining two colors different from the two colors of the first light emitting unit in the group consisting of white, green, blue and red, both the first light emitting unit and the second light emitting unit are dual-cup lamp beads.

As a further improvement of the present disclosure, the light source assembly includes a plurality of light emitting modules, each of the plurality of light emitting modules includes a complete arrangement combination of the at least two types of light emitting units, and light emitting units in each of the plurality of light emitting modules are arranged in transverse, longitudinal, array or annular form.

As a further improvement of the present disclosure, light source lenses are provided on the light emitting module, and the light source lenses correspond to light emitting units in a one-to-one manner; alternatively, a single light source lens covers a plurality of light emitting units on one light emitting module.

As a further improvement of the present disclosure, each type of light emitting unit and each light emitting component in each of the plurality of light emitting modules is capable of being independently controlled, different display effects presented are achieved by controlling lighting states of each light emitting unit.

As a further improvement of the present disclosure, the plurality of light emitting modules are regularly arranged on the light source substrate in a form of a plurality of concentric circles, a multi-loop square-ring pattern or an array.

As a further improvement of the present disclosure, the light source substrate is provided with Ri circles of light emitting units, where Ri≥2, a count of light emitting units in a R1-th circle is N, a count of light emitting units in a R2-th circle is 2N, and a count of light emitting units in a Ri-th circle is i*N.

Another purpose of the present disclosure is to provide a lamp including the above-mentioned light source assembly.

To achieve the above objective, the present disclosure provides a lamp including the above light source assembly.

Compared with other implementations, the technical solution of the present disclosure has the following beneficial effects: the light source assembly of the present disclosure utilizes multiple types of light-emitting units arranged on the light source substrate to achieve changes in light, thereby simulating various different effects such as blue sky, sunset, morning light, and blue sky with white clouds, which improves the user's visual experience.

The present disclosure may include dedicated hardware implementations such as disclosure specific integrated circuits, programmable logic arrays and other hardware devices. The hardware implementations can be constructed to implement one or more of the methods described herein. Examples that may include the apparatus and systems of various implementations can broadly include a variety of electronic and computing systems. One or more examples described herein may implement functions using two or more specific interconnected hardware modules or devices with related control and data signals that can be communicated between and through the modules, or as portions of an disclosure-specific integrated circuit. Accordingly, the system disclosed may encompass software, firmware, and hardware implementations. The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. The module refers herein may include one or more circuit with or without stored code or instructions. The module or circuit may include one or more components that are connected.

The above examples are only used to illustrate the technical solutions of the present disclosure rather than impose limitations thereon. Although the present disclosure has been described in detail with reference to examples, those skilled in the art shall understand that modifications or equivalent substitutions can be made to the technical solutions of the present disclosure without departing from the spirit and scope of the present disclosure.

1. A light source assembly, for use in a lamp, wherein the light source assembly comprises a light source substrate and at least two types of light emitting units on the light source substrate, each of the at least two types of light emitting units comprises at least two light emitting components of different colors, the at least two types of light emitting units are arranged alternately, and the light emitting components in two adjacent light emitting units of a same type are arranged in different color orders.

2. The light source assembly according to claim 1, wherein a first light emitting unit and a second light emitting unit are on the light source substrate, the first light emitting unit comprises two light emitting components of different colors, and the second light emitting unit comprises two light emitting components having colors different from the colors of the two light emitting components in the first light emitting unit.

3. The light source assembly according to claim 2, wherein the first light emitting unit and the second light emitting unit are arranged alternately, and the two light emitting components in adjacent first light emitting units and/or the two light emitting components in adjacent second light emitting units are arranged in reverse order.

4. The light source assembly according to claim 2, wherein the first light emitting unit comprises any two colors selected from a group consisting of white, green, blue and red; the second light emitting unit comprises remaining two colors different from the two colors of the first light emitting unit in the group consisting of white, green, blue and red, both the first light emitting unit and the second light emitting unit are dual-cup lamp beads.

5. The light source assembly according to claim 1, wherein the light source assembly comprises a plurality of light emitting modules, each of the plurality of light emitting modules at least one complete repeating arrangement of the at least two types of light emitting units, and light emitting units in each of the plurality of light emitting modules are arranged in a transverse arrangement, a longitudinal arrangement, an array arrangement, or an annular arrangement.

6. The light source assembly according to claim 5, wherein light source lenses are provided on each light emitting module, and the light source lenses correspond to light emitting units in a one-to-one manner; alternatively, a single light source lens covers a plurality of light emitting units on the light emitting module.

7. The light source assembly according to claim 5, wherein each type of light emitting unit and each light emitting component in each of the plurality of light emitting modules is capable of being independently controlled, wherein lighting states of the light emitting units are independently controllable to generate different display effects.

8. The light source assembly according to claim 5, wherein the plurality of light emitting modules are regularly arranged on the light source substrate in a form of a plurality of concentric circles, a multi-loop square-ring pattern or an array.

9. The light source assembly according to claim 1, wherein the light source substrate is provided with Ri circles of light emitting units, where Ri≥2, a count of light emitting units in a R1-th circle is N, a count of light emitting units in a R2-th circle is 2N, and a count of light emitting units in a Ri-th circle is i*N.

10. A lamp, comprising a light source assembly, wherein the light source assembly comprises:
a light source substrate and at least two types of light emitting units on the light source substrate, each of the at least two types of light emitting units comprises at least two light emitting components of different colors, the at least two types of light emitting units are arranged alternately, and the light emitting components in two adjacent light emitting units of a same type are arranged in different color orders.
